(19) United States
(12) Patent Application Publication
(10) Pub. No.: US 2005/0081393 A1
(43) Pub. Date: Apr. 21, 2005

(54) Invertible laser instrument

(76) Inventors: Kung-Ho Su, Taipei (TW); Chao-Hung Wu, Keelung (TW)

Correspondence Address: Raymond Sun, 12420 Woodhall Way, Tustin, CA, 92782, US

(21) Appl. No.: 10/778,483

(22) Filed: Feb. 13, 2004

(30) Foreign Application Priority Data
Oct. 17, 2003 (TW) 92218443

(51) Int. Cl. G01C 15/00

(52) U.S. Cl. 33/286

(57) ABSTRACT

An invertible laser instrument that has a housing, a laser module disposed inside the housing and having a tenon disposed at the bottom of the laser module, a base disposed at the bottom of the laser module and having a hole at the center of the base, with the tenon inserted into the hole, and a resilient component disposed in the hole to secure the tenon in the hole. The resilient component secures the laser module to the base, so that the laser module will not fall out from the base when the laser instrument is inverted.

### BACKGROUND OF THE INVENTION

1. Field of the Invention

The present invention relates to laser instruments, and in particular, to an invertible laser instrument.

2. Description of the Prior Art

The word “Laser” actually stands for “Light Amplification by Stimulated Emission of Radiation.” It is a form of electromagnetic radiation which is similar to radio and microwave. The difference is that light has a much higher frequency than radio or microwave. Laser is the most common high-energy monochromatic wave. Because of its monochromatic and coherent radiation, high power intensity, fast modulation frequency and beam oriented emission characteristics, laser has become the primary source used in fiber optic communication systems, range finders, interferometers, alignment systems, profile scanners, laser vision correction surgery and many other applications.

Lasers are also commonly used in many other applications, such as in general construction, with level measuring instruments used for construction. Leveling instruments that utilize a common leveler with a water bubble are normally used to determine the levelness of a surface. However, the accuracy of the common leveler with a water bubble is low, so laser levelers have gradually been used to replace these common levelers.

FIGS. 1A and 1B illustrate the base 100 of a conventional laser instrument. The base 100 has a main body 102, a guide axle 104, and a plurality of adjusters 106. The guide axle 104 is a hollow body disposed in a hole 108 at the center of the main body 102, and the adjusters 106 are provided under the main body 102 for adjusting the level of the laser instrument.

FIG. 2A illustrates a conventional laser instrument, which has a housing 110, a laser module 112, and the base 100. The laser module 112 includes a battery tube 114, a metal ring 116, a vertical laser module 118, a horizontal laser module 120, an upper casing 122, and a fixed base 124. The laser module 112 is arranged inside the housing 110 and positioned above the base 100. Referring to FIG. 2B, a tenon 126 having a diameter slightly smaller than the internal diameter of the guide axle 104 is disposed at the bottom of the laser module 112. When combining the laser module 112 with the base 100, the tenon 126 is first inserted into the guide axle 104 of the base 100, and then the base 100 is covered by the housing 110 to complete the assembly of the laser instrument.

FIG. 3 illustrates the battery base of a conventional laser module. The battery tube 114 is typically secured on to a battery base 130, and both the battery tube 114 and the battery base 130 are cast and made of aluminum alloy.

Unfortunately, the assembly of conventional laser instruments still suffers from the following drawbacks:

1. The tenon 126 under the laser module 112 is simply inserted into the guide axle 104 of the base 100. Although the laser module 112 can use the tenon 126 as the axis of rotation, the laser module 112 cannot be fixed onto the base 100. Therefore, if the laser module 112 is accidentally turned upside down, then the laser module 112 will be detached from the base 100 and may be broken.

2. The battery tube 114, the battery base 130, and the main body 102 are cast and made of aluminum alloys, so that the manufacturing cost is high and the operation is inconvenient.

3. The metal ring 116 at the bottom of the laser module 112 is made of copper. If the laser module 112 is turned on for a long time, the metal ring 116 may stick on the circular ring 128 around the metal ring 116 because copper is a good conductor of heat, and because the circular ring 128 is made of a rubber material.

4. The vertical module 118 and the horizontal module 120 of the laser module 112 have a cylindrical glass (not shown in the FIGS.) at their front ends. If the vertical module 118 and the horizontal module 120 are fixed by the upper casing 122 and an improper force is applied, then the cylindrical glass at the front of the vertical module 118 and the horizontal module 120 may break, because the upper casing 122 is smaller in size.

### SUMMARY OF THE INVENTION

It is an object of the present invention to provide a laser instrument which overcomes the drawbacks described above.

It is another object of the present invention to provide a laser instrument which can be turned upside down without damaging any of the internal components or negatively impacting the performance of the laser instrument.

It is yet another object of the present invention to provide a laser instrument which effectively lowers the production cost by changing the materials of some of the parts of the laser instrument.

In order to achieve the objectives of the present invention, there is provided an invertible laser instrument that has a housing, a laser module disposed inside the housing and having a tenon disposed at the bottom of the laser module, a base disposed at the bottom of the laser module and having a hole at the center of the base, with the tenon inserted into the hole, and a resilient component disposed in the hole to secure the tenon in the hole. The resilient component secures the laser module to the base, so that the laser module will not fall out from the base when the laser instrument is inverted.

In accordance with another embodiment of the present invention, the laser module has a horizontal laser module, a vertical laser module and a fixed base that receives the horizontal laser module and the vertical laser module therein. The fixed base has a module base coupled to the horizontal laser module and the vertical laser module, a bearing base coupled to the module base such that the bearing base can rotate about a first axis, and a stand coupled to the bearing base such that the bearing base can rotate about a second axis that is perpendicular to the first axis.

### BRIEF DESCRIPTION OF THE DRAWINGS

FIG. 1A is an exploded view of a conventional base for a laser instrument.

FIG. 1B is a cross-sectional view of the guide axle of the base of FIG. 1A.

FIG. 2A is a perspective view of a conventional laser instrument.

FIG. 2B is an expanded view of a portion of the laser instrument of FIG. 2A.

FIG. 3 is an exploded view of a conventional battery base of a conventional laser module.

FIG. 4A is an exploded perspective view of a base of a laser instrument according to one embodiment of the present invention.

FIG. 4B is an exploded view of some components of the base of FIG. 4A.

FIG. 4C is a cross-sectional view of some components of the base of FIG. 4B.

FIG. 5A is a top perspective view of a laser instrument according to one embodiment of the present invention.

FIG. 5B is an exploded view of certain components of the laser instrument of FIG. 5A.

FIG. 5C is a bottom perspective view of the laser instrument of FIG. 5A.

FIG. 6 is a perspective view if the laser module base and the power supply base of the laser instrument of FIG. 5A.

FIG. 7 is a cross-sectional view of the laser module of the laser module of FIG. 5A.

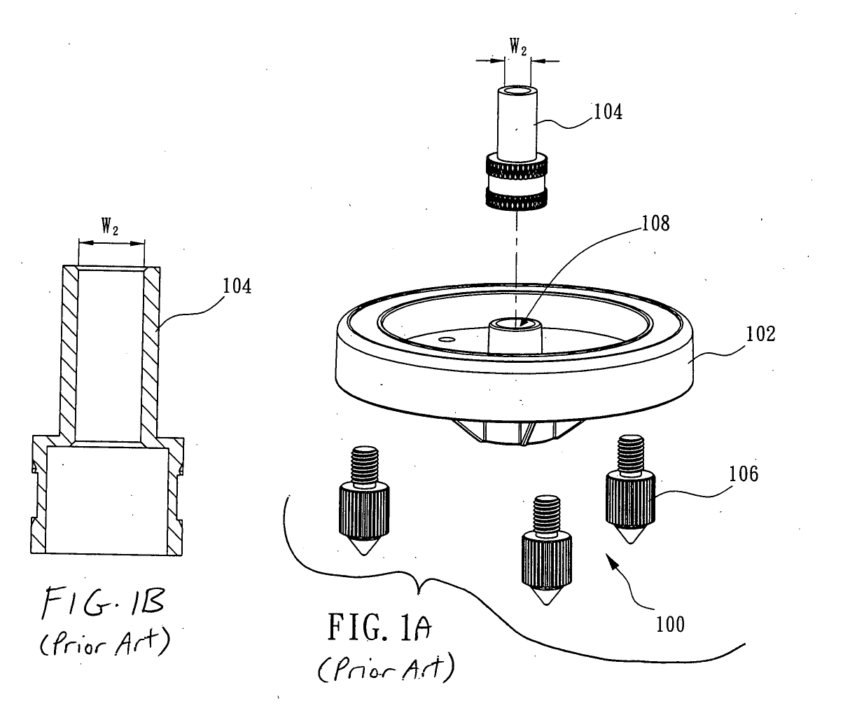

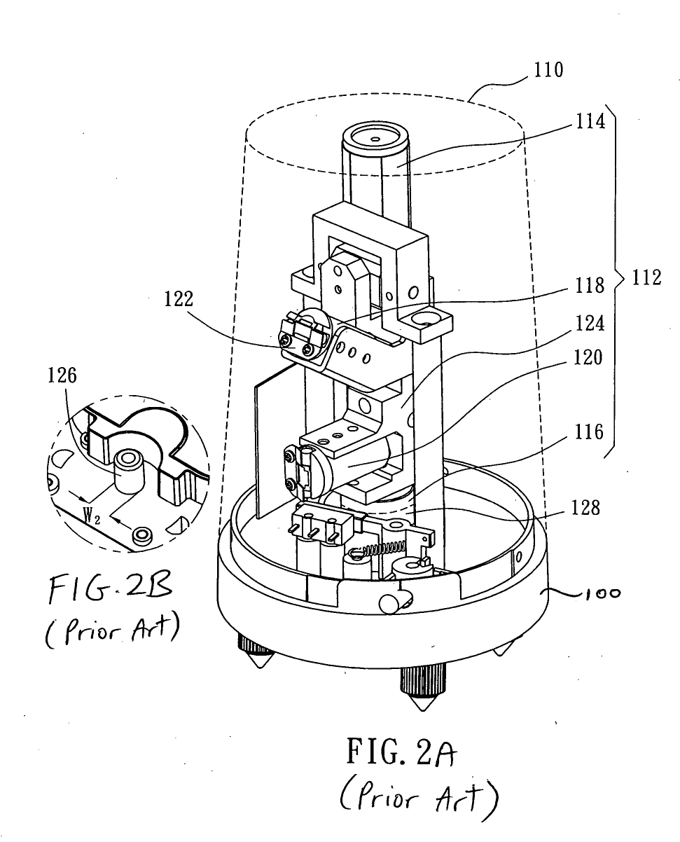

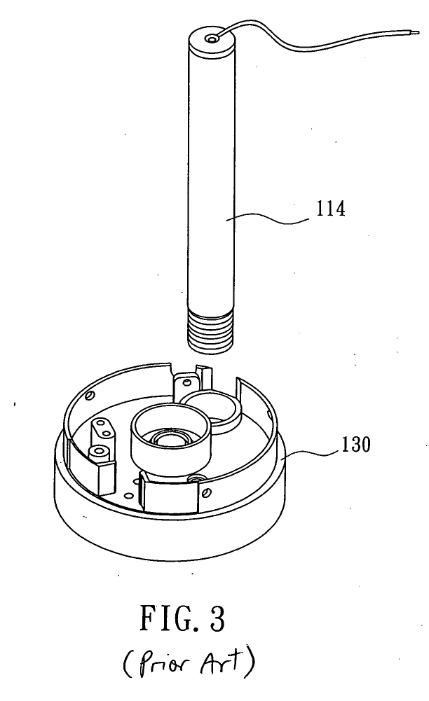

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

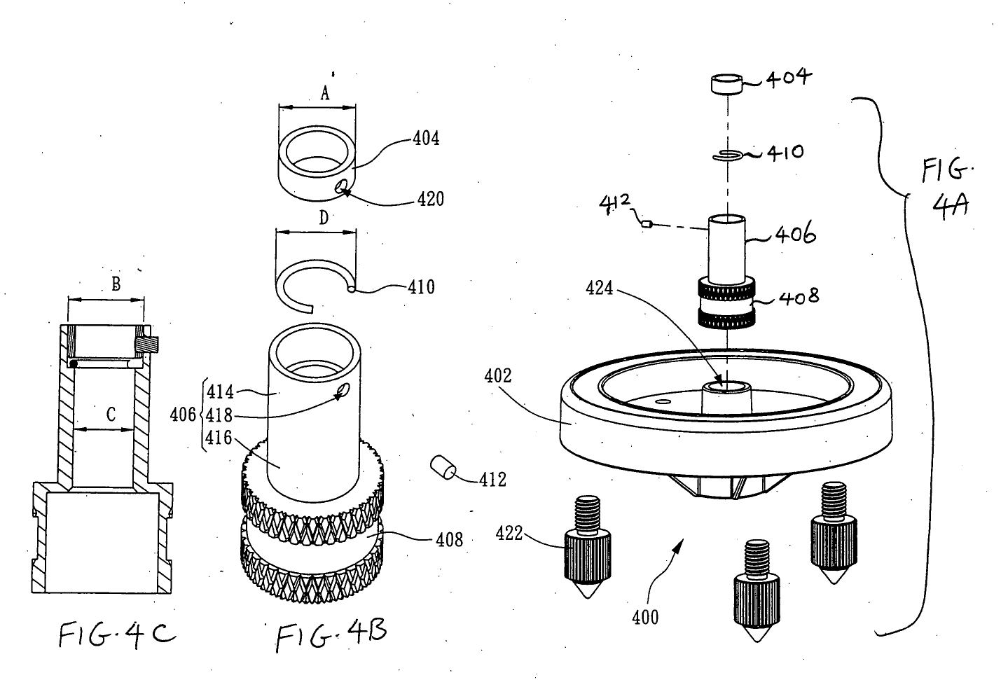

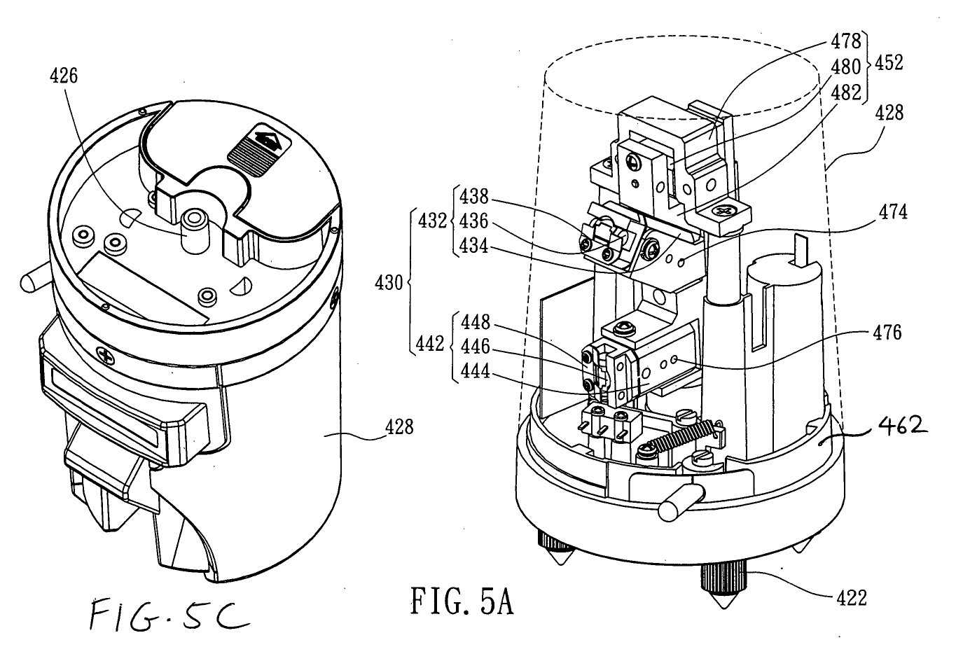

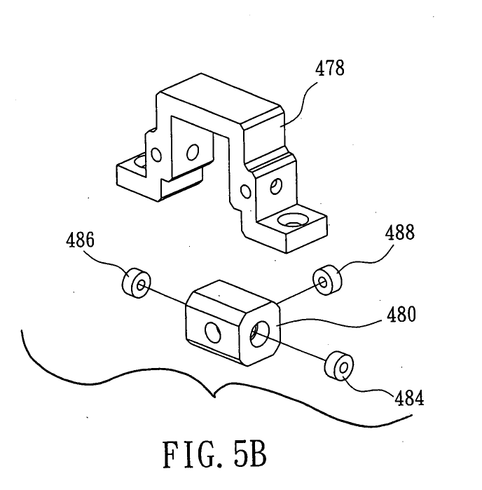

FIGS. 4A-4C and 5A-5C illustrate an inverted laser instrument according to one embodiment of the present invention. The base 400 of the laser instrument has a main body 402, a first metal ring 404, a cylinder 406, a second metal ring 408, a resilient component 410, and a screw 412. The first metal ring 404 and the resilient component 410 are disposed inside the bore of the cylinder 406, and the screw 412 is used to fix the first metal ring 404 inside the cylinder 406. The cylinder 406 and the second metal ring 408 are coupled by screw threads disposed on the external circumference and the internal circumference of the second metal ring 408, which is thereafter integrally formed with the main body 402 at a central hole 424 of the base 400 by plastics injection molding. The screw threads on the external circumference of the second metal ring 408 strengthen the coupling force with the main body 402. The screw threads on the internal circumference of the second metal ring 408 operate in coordination with other components.

The cylinder 406 has a first end 414 and a second end 416 opposite to the first end 414, and a screw hole 418 is provided at the circumference of the first end 414. The internal diameter C of the second end 416 is smaller than the external diameter A of the first metal ring 404, and the external diameter A of the first metal ring 404 is smaller than the internal diameter B of the first end 414 of the cylinder 406. The resilient component 410 (such as a spring) has an external diameter D that is smaller than the internal diameter B of the first end 414, and larger than the internal diameter C of the second end 416. These dimensions allow the resilient component 410 to be secured to the first end 414. The circumference of the first metal ring 404 also has a screw hole 420 which is aligned with the screw hole 418, so that the screw 412 can be inserted through the two screw holes 418, 420 to secure the first metal ring 404 and the cylinder 406 together.

The assembled first metal ring 404, cylinder 406, second metal ring 408, resilient component 410 and screw 412 can be integrally formed with the main body 402 by plastics injection. A plurality of adjusters 422 are then installed at the bottom of the main body 402 to form the base 400. A tenon 426 (see FIG. 5C) disposed at the bottom of the laser module 430 is adapted to be inserted into the bore at the first end 414. The resilient component 410 expands to produce a securing force that presses against the tenon 426, so even if the laser module 430 is turned upside down, the laser module 430 will not fall off from the central hole 424 of the base 400.

FIG. 5A illustrates an invertible laser instrument and an inverted laser module according to one embodiment of the present invention, which includes a housing 428, a laser module 430 and the base 400.

Referring to FIG. 5A, the laser module 430 includes a vertical laser module 432, a horizontal laser module 442, and a fixed base 452. The vertical laser module 432 and the horizontal laser module 442 are fixed in the fixed base 452. The vertical laser module 432 has a vertical laser 434, a lens 436, and an upper casing 438. Similarly, the horizontal laser module 442 has a horizontal laser 444, a lens 446, and an upper casing 448. The lens 436 and 446 are fixed onto the front ends of the vertical laser 434 and the horizontal laser 444 by the respective upper casings 438 and 448. The vertical laser module 432 is positioned at the top of the horizontal laser module 442, and the intersection angle between them is about 20-60 degrees, and the dispersion angle of the laser beam emitted from the vertical laser module 432 and the horizontal laser module 442 is about 110-130 degrees. When the laser beam is projected on a wall, it is a red laser beam formed by two perpendicular beams. In addition, the vertical laser module 432 and the horizontal laser module 442 at their lateral sides have a plurality of adjusting buttons 474, 476 for adjusting the positions of the vertical laser 434 and the horizontal laser 444 respectively, so that the vertical laser beam and horizontal laser beam can be emitted from the correct positions.

The housings of the fixed base 452, the vertical laser 434 and the horizontal laser 444 can be made of a zinc alloy having a specific gravity greater than that of aluminum. The diameter of the top of the upper casings 438, 448 can be 12-17 mm, which is intended to increase the area for exerting a force on the upper casings 438, 448 to prevent the respective lens 436, 446 from breaking due to excessive forces or improper adjustments when the upper casings 438, 448 are used to fix the lens 436, 446 on to the front ends of the vertical laser 434 and the horizontal laser 444, respectively.

Referring to FIGS. 5A and 5B, the fixed base 452 has a stand 478, a bearing base 480, and a module base 482, with the stand 478 and the bearing base 480 coupled by two rotary bearings 484, 486 in a manner such that the bearing base 480 can rotate freely around an axis defined by the rotary bearings 484, 486. The bearing base 480 also uses another rotary bearing 488 to couple with the module base 482, such that the laser module 430 located inside the module base 482 can rotate freely around an axis defined by the rotary bearing 488. Therefore, the laser module 430 can move freely in a three-dimensional space inside the fixed base 452, so that the laser module 430 can be positioned more precisely.

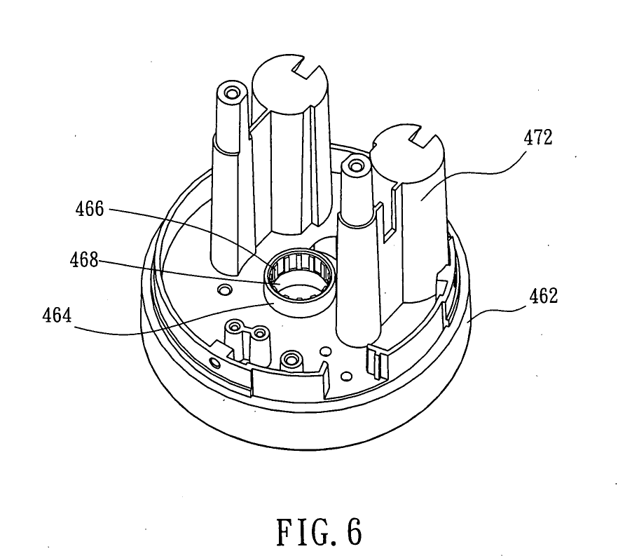

Referring now to FIG. 6, the laser module 430 also includes a laser module base 462 and a power supply base 472, with the laser module base 462 and the power supply base 472 integrally formed by plastics injection molding to effectively lower the manufacturing cost. A metal ring 464 is disposed on the laser module 430, and the internal circumference of the metal ring 464 has a plurality of protruding rib sections 466. The metal ring 464 can be made of an aluminum alloy because of its low cost and extrudable feature. Many protruding rib sections 466 can be produced at the same time. The plurality of protruding rib sections 466 not only increases the area for heat dissipation, but also reduces the contact area with the silicon rubber 468 to prevent the silicon rubber 468 from sticking on to the aluminum metal and thereby affecting the life of the laser instrument after extended use.

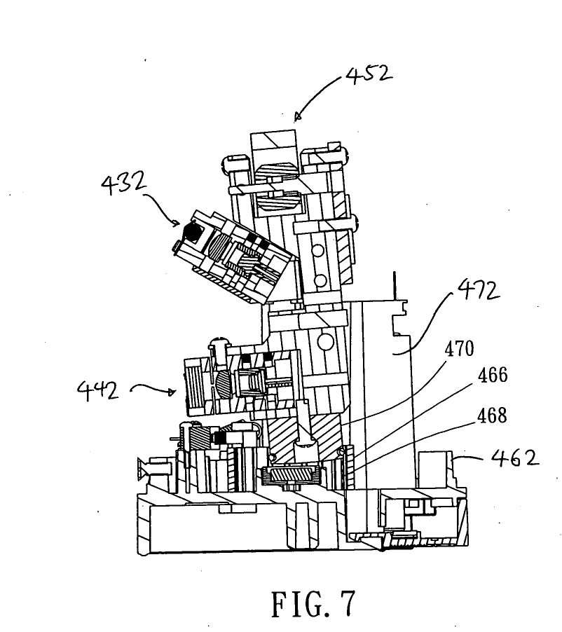

FIG. 7 is a cross-sectional view of the invertible laser instrument of FIGS. 4-6. If the laser module 430 is used on a surface with an inclination of less than three degrees, the emitted horizontal laser beam and vertical laser beam will remain in an acceptable precision range. Since there is a movement core 470 at the top of the silicon rubber 468, if the laser instrument is set on a horizontal surface with an inclination larger than three degrees, then the movement core 470 will be in contact with the metal ring 466, and then the emitted laser beam(s) will blink. This blinking indicates that the emitted laser beam has exceeded the desired precision range, and it is possible to disable the laser instrument so that it cannot be used any further. At this time, the user will need to adjust the adjusters 422 at the bottom of the base 400 until the emitted laser beam(s) no longer blinks, before the user is able to continue use of the laser instrument.

Thus, in accordance with the present invention, the resilience of a resilient component 410 is used to press tightly against the tenon 426 of the laser module 430, so that the laser module 430 can remain fixed to the base. As a result, even if the laser instrument is inverted, the laser module 430 will not fall out from the laser instrument.

In light of the above, the invertible laser instrument of the present invention has at least the following advantages:

1. The use of a resilient component 410 to tightly press against the tenon 426 of the laser module 430, so that even if the laser module 430 is inverted, it will not fall out from the base 400.

2. The use of integral plastics injection molding for the formation of the power supply base 472 and the laser module base 462 effectively lowers the manufacturing cost.

3. The use of integral plastics injection molding for the formation of the main body 402, the metal ring 404, and the resilient component 410 to manufacture the base 400 effectively lowers the cost.

4. The use of zinc alloy with a relatively larger density for the fixed base 452 provides a more secured weight and faster positioning.

5. The provision of an upper casing 438, 448 with a size larger than conventional upper casings effectively increases the area of exerting forces and prevents the lens from breaking when the lens is mounted.

6. The use of a metal ring 464 made of aluminum instead of copper. The internal circumference of the metal ring 464 has a plurality of protruding rib sections 466 to reduce the contact area with the silicon rubber and to prevent the silicon rubber from sticking to the metal ring 464. The manufacturing method can be changed from lathe manufacture to extrusion, which can effectively lower the cost.

7. The rotation of the laser module 430 by three rotary bearings 484, 486, 488 allows the laser module 430 to move freely in a three-dimensional space, and provides a more precise positioning for the laser module 430.

While the description above refers to particular embodiments of the present invention, it will be understood that many modifications may be made without departing from the spirit thereof. The accompanying claims are intended to cover such modifications as would fall within the true scope and spirit of the invention.

1. An invertible laser instrument, comprising:
a housing;
a laser module disposed inside the housing and having a tenon disposed at the bottom of the laser module;
a base disposed at the bottom of the laser module and having a hole at the center of the base, with the tenon inserted into the hole; and
a resilient component disposed in the hole to secure the tenon in the hole.

2. The instrument of claim 1, wherein the laser module includes:
a horizontal laser module having a horizontal laser, a lens, and an upper casing that fixes the lens to the horizontal laser module;
a vertical laser module having a vertical laser, a lens, and an upper casing that fixes the lens of the vertical laser module to the vertical laser module, with the vertical laser module being positioned at the top of the horizontal laser module, and disposed at an intersection angle of 20-60 degrees; and
a fixed base that receives the horizontal laser module and the vertical laser module therein.

3. The instrument of claim 2, wherein the horizontal laser module and vertical laser module each includes a plurality of adjusting buttons for adjusting the positions of the horizontal laser and the vertical laser.

4. The instrument of claim 2, wherein each of the horizontal laser module and the vertical laser module individually emits a laser beam having a dispersion angle that ranges between 110-130 degrees.

5. The instrument of claim 2, wherein the fixed base is made of a zinc alloy.

6. The instrument of claim 2, wherein each of the horizontal laser and the vertical laser individually has a housing made of a zinc alloy.

7. The instrument of claim 2, wherein each of the upper casings of the horizontal laser module and the vertical laser module has a top with a diameter ranging between 12-17 mm.

8. The instrument of claim 1, wherein the laser module further includes a laser module base and a plurality of power supply bases that are disposed on top of the laser module base.

9. The instrument of claim 8, wherein the laser module base and the power supply base are integrally formed by plastics injection molding.

10. The instrument of claim 1, wherein the laser module further includes a metal ring made of aluminum.

11. The instrument of claim 10, wherein the internal diameter of the metal ring has a plurality of protruding ribs.

12. The instrument of claim 10, wherein the metal ring is integrally formed by extrusion.

13. The instrument of claim 1, wherein the base is made of plastic.

14. The instrument of claim 1, wherein the base includes:
a main body;
a first metal ring;
a cylinder having a first end and a second end, with the internal diameter of the first end being smaller than the internal diameter of the second end, and with the resilient component disposed at the first end;
a second metal ring coupled to the cylinder; and
a screw;
wherein the circumference of the first metal ring and the circumference of the first end of the cylinder each has a screw hole, with the screw passing through the screw holes to secure the first metal ring and the cylinder.

15. The instrument of claim 14, wherein the resilient component has an external diameter that is smaller than the internal diameter of the first end of the cylinder, and larger than the internal diameter of the second end of the cylinder.

16. The instrument of claim 14, further including a third metal ring coupled to the cylinder, the third metal ring having internal and external circumferences that have provided thereon a plurality of threads.

17. The instrument of claim 14, wherein the resilient component, the first metal ring, the cylinder, and the second metal ring are assembled, and then integrally formed on the base by plastics injection molding.

18. The instrument of claim 1, further including a plurality of adjusters arranged at the bottom of the base.

19. An invertible laser instrument, comprising:
(i) a housing;
(ii) a laser module disposed inside the housing, the laser module including a horizontal laser module, a vertical laser module;
(iii) a fixed base that receives the horizontal laser module and the vertical laser module therein, the fixed base further including:
a module base coupled to the horizontal laser module and the vertical laser module;
a bearing base coupled to the module base such that the bearing base can rotate about a first axis; and
a stand coupled to the bearing base such that the bearing base can rotate about a second axis that is perpendicular to the first axis; and
(iv) a base disposed at the bottom of the laser module.

20. The instrument of claim 19, wherein:
the bearing base is coupled to the module base about a first rotary bearing; and
the stand is coupled to the bearing base about second and third rotary bearings.
